(19) United States
(12) Patent Application Publication
(10) Pub. No.: US 2009/0044961 A1
(43) Pub. Date: Feb. 19, 2009

(54) Electrical hand-held power tool

(76) Inventors: Stefan Schmid, Untermuehlhausen (DE); Holger Cecchin, Puchheim (DE)

Correspondence Address: ABELMAN, FRAYNE & SCHWAB, 666 THIRD AVENUE, 10TH FLOOR, NEW YORK, NY, 10017, US

(21) Appl. No.: 12/228,798

(22) Filed: Aug. 15, 2008

(30) Foreign Application Priority Data
Aug. 16, 2007 (DE) 10 2007 038 555.4

(51) Int. Cl. B25B 33/00

(52) U.S. Cl. 173/46

(57) ABSTRACT

An electrical hand-held power tool includes an outer housing (12) in which there are located a percussion mechanism (18), a motor (16) for driving the percussion mechanism (18), a gear unit (17) for connecting the motor (16) with the percussion mechanism (18), a control electronics (19) for controlling operation of the power tool (11), and a closed cooling circuit (21) for cooling medium for cooling above-listed components of the power tool (11). A heat exchanger (26), which is fixedly connected with the power tool (11), is arranged in the cooling circuit (21) for cooling the cooling medium.

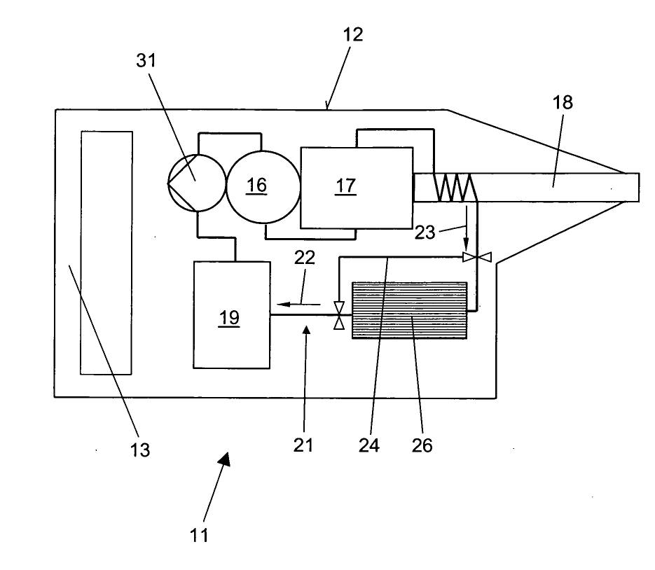

### BACKGROUND OF THE INVENTION

1. Field of the Invention

The present invention relates to an electrical hand-held power tool including an outer housing in which there are arranged a percussion mechanism, a motor for driving the percussion mechanism, a gear unit for connecting the motor with the percussion mechanism, a control electronics for controlling operation of the power tool, and a closed cooling circuit for cooling medium for cooling above-listed components of the power tool.

2. Description of the Prior Art

In electrical hand-held power tools with a percussion mechanism such as hammer drill, combination or chisel hammer, the mechanical energy, which is produced by the motor, is converted by the gear unit and the percussion mechanism in a rotary and/or percussion movement of a working tool received in the power tool.

In order to remove the generated heat, electrical hand-held power tools with a forced aeration are used. In these power tools, a cooling outside air is propelled by a ventilator through the power tool. The drawback of this solution consists in that the these power tools do not provide any protection with regard to moisture that would conform to the requirements of International Standard as defined by a respective IPX Code, or would provide such protection only with large constructive expenditures. IPX Code (IP stands for “International Protection” which sometimes is interpreted as “Ingress Protection”) classifies the level of protection of instruments and equipment inside an enclosure against harmful ingress of water. E.g., IPX4 indicates protection against splashing water, IPX5 indicates protection against water jets. E.i., in both cases, no harmful effect on the operation of an instrument or equipment occurs. Thus, IPX Code indicates the suitability of an instrument of equipment, of a power tool in the present case, for different environmental conditions.

German Patent Publication DE 100 37 418 A1 discloses an electrical hand-held power tool including an outer housing in which there are arranged a percussion mechanism, a motor for driving the percussion mechanism, a gear unit for connecting the motor with the percussion mechanism, a control electronics for controlling operation of the power tool, and a closed cooling circuit for cooling medium for cooling the above-listed components of the power tool. With a closed cooling circuit, an electrical hand-held power tool can be completely sealed outwardly and, thereby insures type of protection defined by the code IPX4 and higher without particularly large expenses.

The drawback of the power tool disclosed in DE 100 37 418 A1 consists in that the cooling medium cannot satisfactorily release the absorbed heat into environment after a long-lasting operation and, thereby heats up. Therefore, the operation of the power tool should be stopped until an adequately low temperature level of the cooling medium is reached.

Accordingly, an object of the present invention is to provide an electrical hand-held power tool with a closed cooling circuit for cooling power tool components and which insures type of protection defined by Code IPX4 and higher and enables a lasting operation of the power tool for a long period of time.

### SUMMARY OF THE INVENTION

This and other objects of the present invention, which will become apparent hereinafter, are achieved by providing in the cooling circuit a heat exchanger fixedly connected with the power tool. The heat exchanger extracts the heat from the heated cooling medium that absorbed it from the power tool components, and insures an adequately low temperature level of the cooling medium for cooling the power tool components. Advantageously, liquid cooling medium is used, e.g., water. The power tool with a closed cooling circuit that includes a heat exchanger, can operate for a much longer period of time than known percussion electrical hand-held power tools.

In this connection, under a heat exchanger is understood an apparatus that increases the surface between a cooling medium, e.g., liquid cooling medium, such as water, and another medium, e.g., a gaseous medium, such as air. Advantageously, the heat exchanger is formed of a material having a good heat conductance and a large surface. The heat exchanger has, e.g., tubes or hollow plates formed of metal and which reciprocate in a limited space, and through which the cooling medium flows. Thereby, a larger surface is provided for transfer of heat to the other medium than with a pure liquid through-flow, as disclosed in DE 100 37 418 A. Such heat exchangers are called heat transmitters. The heat exchange is effected by a free convection. Alternatively, the heat exchange can be effected by a forced convection, e.g., with a fan mounted on the heat exchanger.

With a closed cooling circuit arranged in the outer housing and with a heat exchanger fixedly connected with the power tool, a complete encapsulation of the components of the electrical hand-held power tool becomes possible, in addition to insuring an adequate cooling of the power tool components. The requirements for type of protection, which is defined by code IPX4 and higher, are met with a simple construction of the electrical hand-held power tool. The user can use the inventive electrical hand-held power tool during rain in an open-air environment or under humid environmental conditions. In addition, the inventive electrical hand-held power tool can be used all-round, without hindrance that may be caused by elements projecting from the power tool. This is because the inventive electrical hand-held power tool, while insuring an adequate cooling of power tool components, does not require any external cooling apparatus or an external connection for the cooling medium.

Advantageously, the heat exchanger is arranged in the cooing circuit upstream of the control electronics in a flow direction of the cooling medium. This insures an advantageous cooling of the control electronics. This is because the cooling medium, which was cooled by the heat exchanger, is not heated again by another heat-releasing component of the power tool. Thereby, a strong protection of electronic components from overheating is insured even at a lasting operation of the power tool for a very long period of time.

Preferably, the heat exchanger is arranged on the outer housing of the power tool for a direct heat exchange with the surrounding air. This insures an advantageous heat transmission from the cooling medium to the air that surrounds the power tool, and provides for a simple construction of the power tool.

In an advantageous embodiment of the present invention, the heat exchanger is mounted on the outer side of the outer housing for a better heat transmission. The conduits of the cooling circuit extend through the outer housing with the leadthroughs being preferably sealed.

Advantageously, a pressure-generating pump for the cooling medium is arranged in the cooling circuit downstream of the heat exchanger in a flow direction of the cooling medium. The cooling medium is constantly pumped through the heat exchanger, and the cooling medium is brought to a low level for an adequate cooling of the power tool components. Advantageously, the pump is located between the control electronics and the motor and is mechanically connected with the motor for being driven thereby.

Advantageously, a bypass is provided in cooling circuit for bypassing the heat exchanger. The bypass is advantageously temperature-controlled for bypassing the heat exchanger.

At low environmental temperatures, an optimal operational temperature of the power tool is rapidly achieved. As soon as the operational temperature is achieved, the cooling medium is again passed through the heat exchanger for an adequate cooling of the power tool components. Advantageously, dependent on the type of the control used, correspondingly formed valves are provided at the ends of the bypass.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

In the drawings:

Single FIGURE shows a schematic side view of an electrical hand-held power tool according to the present invention.

### DETAILED DESCRIPTION OF THE PREFERRED EMBODIMENT

A liquid-cooled electrical hand-held power tool 11 according to the present invention, which is shown in the drawing, has an outer housing 12 with a handle 13. In the outer housing 12, there are arranged a motor 16, a gear unit 17, a percussion mechanism 18, and control electronics 19. A closed cooling circuit 21 is completely arranged in the outer housing 12 for cooling the above-listed components of the power tool 12. The cooling circuit 21 includes a heat exchanger 26 for cooling a liquid cooling medium. The heat exchanger 26 communicates with the environment and, to this end, is arranged directly on the housing 12.

The heat exchanger 26 is located in the cooling circuit 21 upstream of the control electronics 19 in the direction of flow of the cooling medium. In order to insure an adequate flow velocity of the cooling medium in the cooling circuit 21, there is provided a pressure-generating pump 31 which is arranged in the cooling circuit 21 downstream, in the cooling medium flow direction, of the heat exchanger 26. In the drawing, the flow direction of the cooling medium is shown with arrows 22 and 23.

Further, there is provided, in the cooling circuit 21, a bypass 24 for bypassing the heat exchanger 26. Through the bypass 24, the cooling medium can be guided around the heat exchanger 26 until an optimal operational temperature of the electrical power tool is reached.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An electrical hand-held power tool, comprising an outer housing (12); a percussion mechanism (18) located in the outer housing (12); a motor (16) located in the housing (12) for driving the percussion mechanism (18); a gear unit (17) for connecting the motor (16) with the percussion mechanism (18); a control electronics (19) likewise located in the housing (12) for controlling operation of the power tool (11); a closed cooling circuit (21) arranged in the outer housing (12) for cooling medium for cooling above-listed components of the power tool (11); and a heat exchanger (26) arranged in the cooling circuit (21) for cooling the cooling medium and fixedly connected with the power tool (11).

2. An electrical hand-held power tool according to claim 1 wherein the heat exchanger (26) is arranged in the cooling circuit (21) upstream of the control electronics (19) in a flow direction of the cooling medium.

3. An electrical hand-held power tool according to claim 1, wherein the heat exchanger (26) is arranged on the outer housing (12).

4. An electrical hand-held power tool according to claim 1, further comprising a pressure-generating pump (31) for the cooling medium arranged in the cooling circuit (21) downstream of the heat exchanger in a flow direction of the cooling medium.

5. An electrical hand-held power tool according to claim 1, further comprising a bypass (24) provided in the cooling circuit for bypassing the heat exchanger (26).
